(19) United States
(12) Patent Application Publication
(10) Pub. No.: US 2011/0090765 A1
(43) Pub. Date: Apr. 21, 2011

(54) Disposable Elapsed Time Tracking Device, Having LCD Display

(76) Inventor: Kevin Brote, Holden, MA (US)

(21) Appl. No.: 12/603,577

(22) Filed: Oct. 21, 2009

(51) Int. Cl. G04F 10/00; G04B 47/00

(52) U.S. Cl. 368/10; 368/107

(57) ABSTRACT

A new disposable, elapsed time tracking device, having led display which generally comprises a main container cap or cover, an electronic elapsed time counter with memory and user interface functions, a LCD display, a battery, and any associated electronic wiring, which when combined will provide the user with a new & novel way for a user to know when a prescription, vitamin, or other article was last removed from the container, which will assist users in timely self medication.

### CROSS-REFERENCE TO RELATED APPLICATIONS

This application claims the benefit of U.S. Provisional Application No. 6/116,997 filed on Oct. 21, 2008.

### FIELD OF THE INVENTION

This invention relates generally to the field of pill, caplet, capsule, and tablet containers and usage reminder devices. Moreover it pertains specifically to a disposable elapsed time tracking device, having LCD display that will assist users in timely self medication.

### BACKGROUND OF THE INVENTION

People often need an easy reminder of the time that has elapsed since their last pill intake. Today a large number of the population has a daily regimen of medications and or vitamins in the form of pills, caplets, capsules, and or tablets. Keeping track of the time that has elapsed since their last pill intake, can be a confusing task. Prior art cap or cover devices for tracking elapsed time are either manual or complicated and expensive to manufacture. The manual devices depend on a user's memory to initiate use by push button activation etc., other types embody a complex digital readout and use/reset function, making the cost of such a device prohibitive. There is therefore a need for an easy to use, automatic elapsed time tracking device as disclosed herein.

### SUMMARY OF THE INVENTION

In view of the limitations now present in the prior art, the present invention provides a new and useful disposable elapsed time tracking device having LCD display which is more efficient in application, more universally usable and more versatile in operation than known devices of this kind.

The purpose of the present invention is to provide a new disposable elapsed time tracking device, having LCD display that will assist users in timely self medication. It is also a purpose of the present invention to provide a new disposable elapsed time tracking device, having LCD display that has many novel features not offered by the prior art apparatus that result in a new disposable elapsed time tracking device, having LCD display which is not apparent, obvious, or suggested, either directly or indirectly by any of the prior art apparatus.

### DETAILED DESCRIPTION OF THE PREFERRED EMBODIMENTS

The present invention in the preferred embodiment generally comprises an electronic elapsed time counter 110 with memory 120 and user interface functions 130, a battery 140, a LCD display 150, and any associated electronic wiring 160, which when combined, and embodied within an item such as a cap 170 or cover, will provide the user with a new & novel way for a user to know when a prescription, vitamin, or other article was last taken. A high percentage of the population is taking multiple medications on a daily basis. Remembering when the last dose of a certain medication was taken can be quite difficult or even impossible for some people. The present invention as disclosed herein will ad an elapsed time tracking device 180 with memory 120 to an ordinary pill bottle 190 cover or cap 170. An LCD display screen 150 having a generally rectangular shape is disposed on the top center of the cover or cap 170, and thereon displaying when the bottle 190 or container was last opened, further displaying the duration of time that has elapsed since the container 190 was previously opened, whereby the time is visually represented for display to a user in the increments of days-hours-minutes with terminology such as “Last Opened” displayed with the “days”, “hours”, “minutes” of the previous opening. One possible visual representation of the elapsed time data may dispose the associated corresponding alpha-numeric character next to, under, or above, the “day”, “hours”, “minutes”, indicators on the LCD display, such as “D” under the three digit “day” display, “H” under the two digit “hour” display, and “M” under the two digit “minute” display. Additionally, terminology such as “Ago” may be printed after the LCD display, thereby giving the user a clear and easy to read visual representation of the last time that a specific container was opened for use.

Herein is one textual example of what may be displayed on the LCD display:
Last Opened 014:07:32 ago
D H M

A key benefit of the present invention is that it can be manufactured for lower cost than existing prior art devices. The invention will operate in one of two modes, an “in use” or “on” mode, and a “hibernation” mode. The display will remain in “hibernation” mode during non use to minimize battery usage. The “on” mode, which illuminates the LCD Display 150, can be activated by means of wiggling or otherwise moving the cap 170 slightly which will thereby activate the LCD display 150 portion of the invention.

Once activated and “in use”, the invention will again initiate “hibernation” mode when the cover or cap 170 remains in a non moving state for a manufacturer or user defined period of time, this is to save on battery life and to keep the size of the battery 140 and cost at a minimum. It is to be understood that the timer counter 110 component of the device will continue to calculate and track the elapsed time weather the device is in the “on” or “hibernation” mode. The time displayed on the cap 170 will remain visible after the cap 170 is removed and will stay visible while the cap 170 is off. The display 150 will then reset to 0 when the cap 170 is reinstalled on the container 190. The Electronic LCD display 150 component of the invention will act to continually track the elapsed time between uses as disclosed herein, and will further keep a digital log of all usage time periods within the LCD/counter component memory, which can be accessed in the event the information is needed for any reason.

The present invention may embody a variety of initial activation or initiation methods such as a paper pull tab which when pulled will activate the elapsed time counter, or a button, which when pushed will activate the elapsed time counter, and other methods not referred to herein which will perform the same function and are to be considered apparent and obvious to the disclosure.

The present invention disclosed herein will provide many benefits to both users and caregivers including but not limited in use to, a medical time line in the event of a death or sudden illness, forensic time lines in the event of death by overdose.

It is to be understood that while the preferred embodiment of the invention is disposable after use, alternate embodiments of the invention may allow for use in a non-disposable manner which allows a user to continually re-use the invention.

It is to be further understood that the present invention, while embodied within the cap in the preferred embodiment, in alternate embodiments may be affixed to the side region of the container whereby it will engage, and operate with, the cap device.

The present invention may be embodied within a variety of container caps having a variety of shapes and or sizes while still performing the purpose and function disclosed herein and is therefore to be considered apparent and obvious to the disclosure.

It is to be understood that the present invention in alternate embodiments may allow a user to monitor the usage or consumption of a variety of substances including but not limited in use to, human or animal prescription and or OTC (over the counter) medications, vitamins or supplements, foods, pet foods such as fish food, cat food, dog food, etc., substances such as nicotine, natural or organic substances or medications, a well as any other item that a user may want to monitor the intake on an hourly, daily, weekly, bi-weekly, monthly or other periodic basis. It is to be further understood that the present invention may be utilized as a cap on containers of various sizes which house or contain a wide variety of products including but not limited in use to, vitamins, medications, pet food or treats, candy, mints, plant fertilizer sticks, and other products not referred to herein which a user may have a need to count or monitor the periodic use of.

The invention as disclosed herein may further comprise hardware/software that is able to continually operate in cold temperature environments such as that found in a refrigeration or freezer unit, as many types of medication, vitamins, food substances, etc., require refrigeration during use.

Although the foregoing description is specific, it should not be considered as a limitation on the scope of the invention, but only as an example of the preferred embodiments. Many variations are possible within the teachings of the invention. For example, the present invention may embody a variety of different display shapes, colors, materials, dimensions, etc. In addition, the relative positions and shapes of the elements can vary.

The foregoing has outlined the detailed description of the physical aspects of the invention and is to serve as an aid to better understanding the intended use and function of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention.

FIG. 1 shows a series of Plan views and Associated Elevation views of a Disposable Elapsed Time Tracking Device, Having LCD Display according to the present invention in various embodiments.

FIG. 2 shows a series of 2 Plan views and 2 Associated Elevation views, of a Disposable Elapsed Time Tracking Device, Having LCD Display according to the present invention in various embodiments, as well as 2 front elevation views showing the invention represented in 2 addition embodiments.

FIG. 3 shows 2 Plan views and 2 Elevation views of a Disposable Elapsed Time Tracking Device, Having LCD Display according to the present invention in 3 separate distinct embodiments.

FIG. 4 shows a Plan view of one possible embodiment of a Disposable Elapsed Time Tracking Device, Having LCD Display according to the present invention.

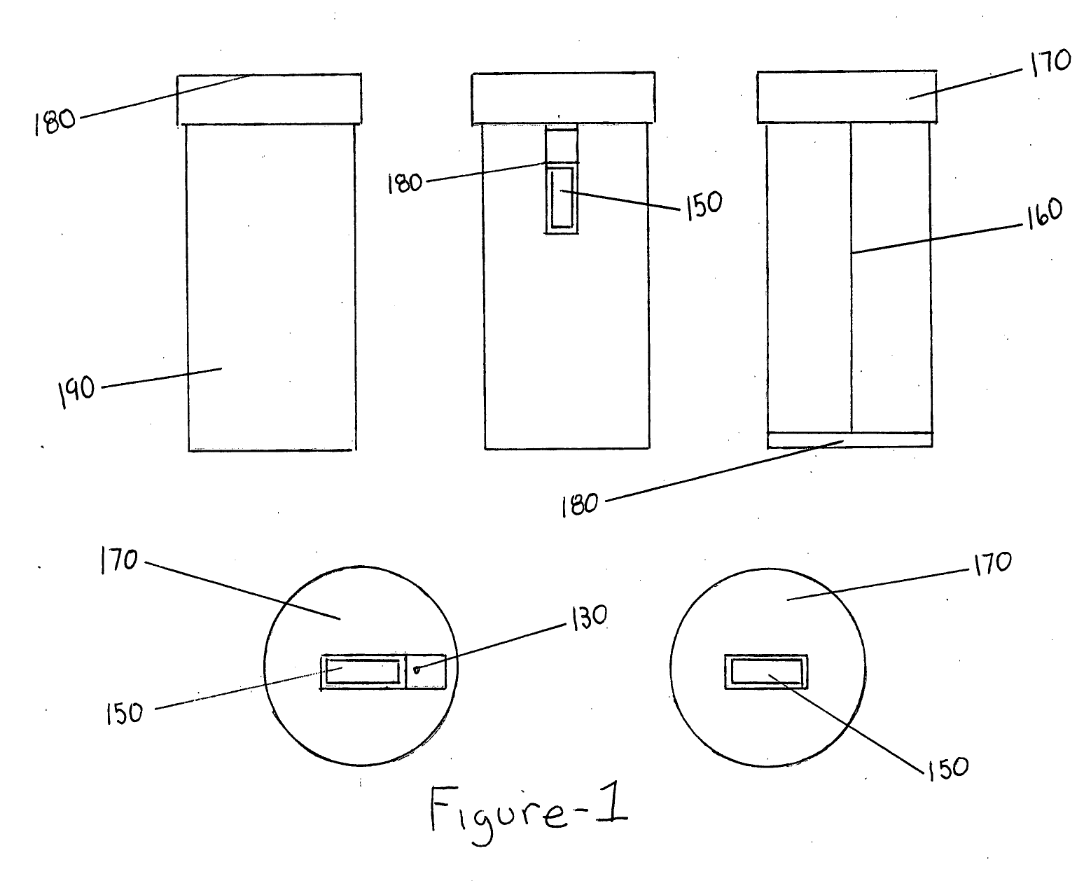

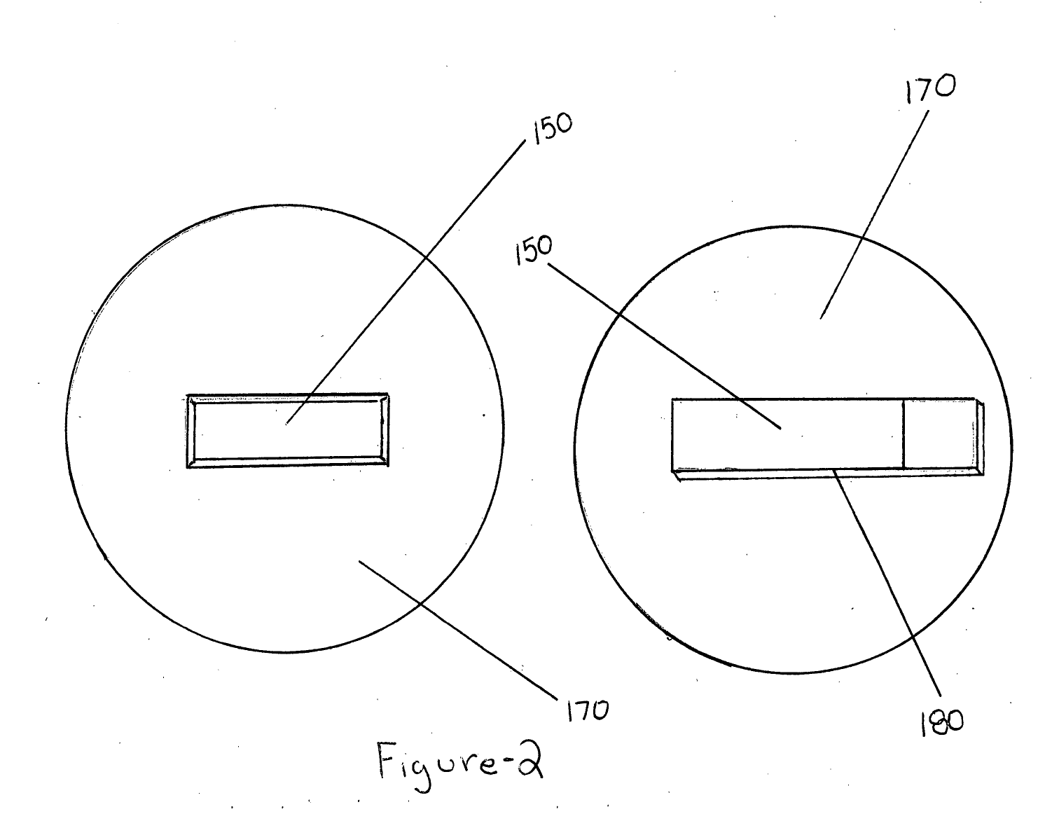

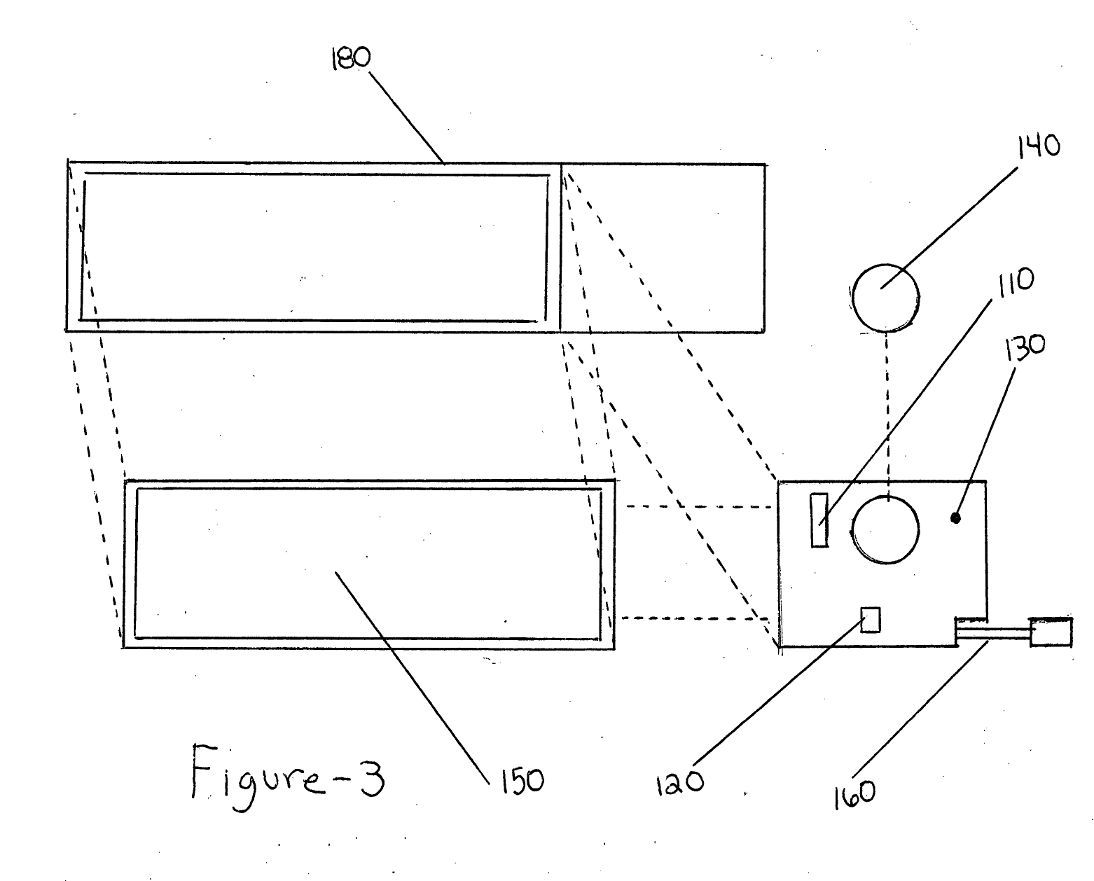

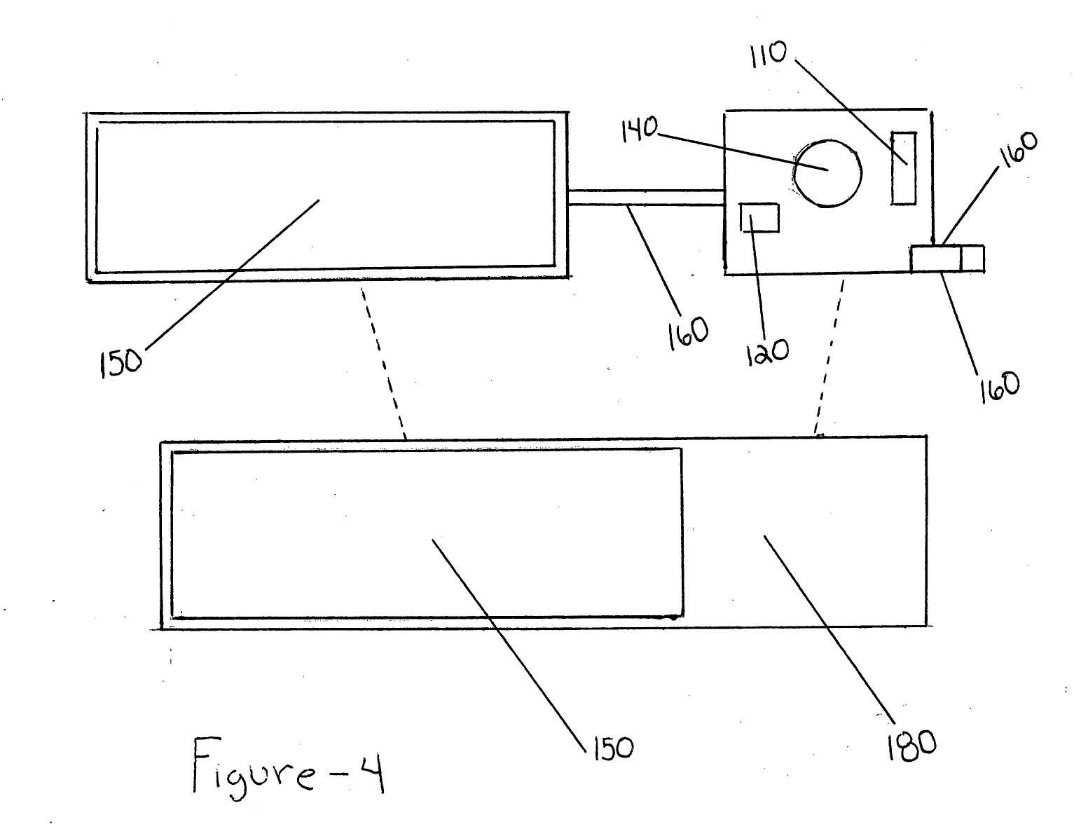

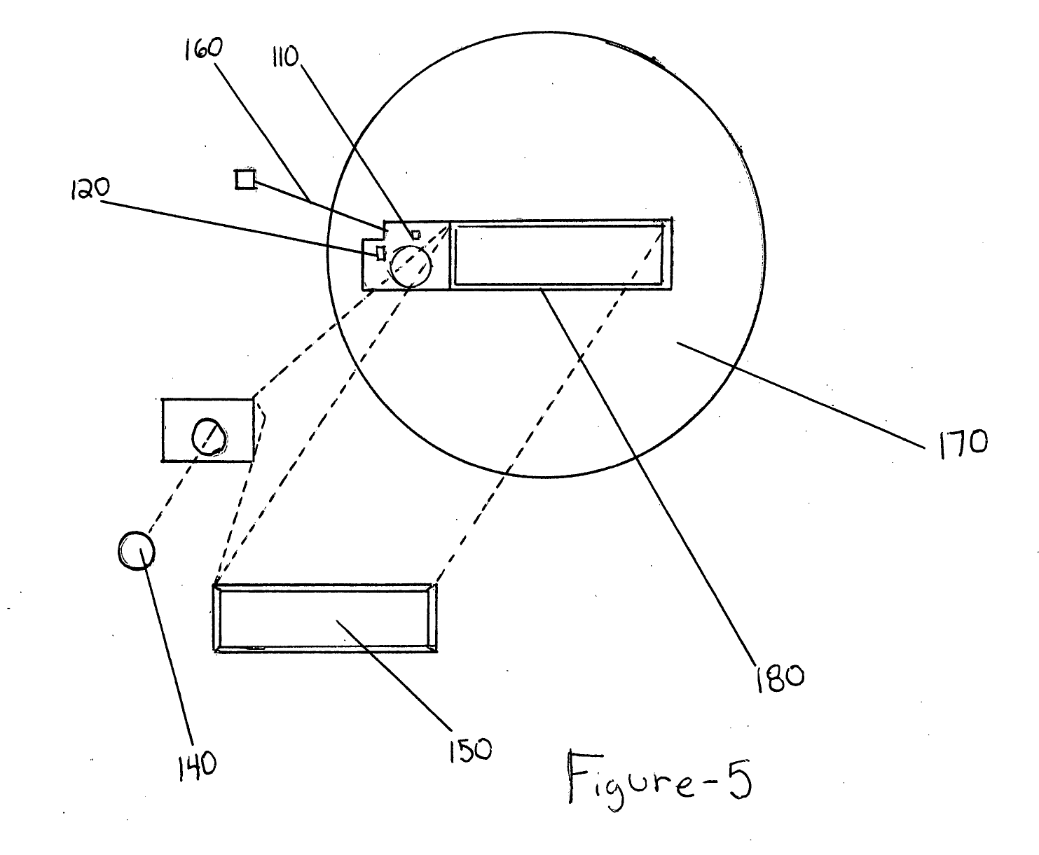

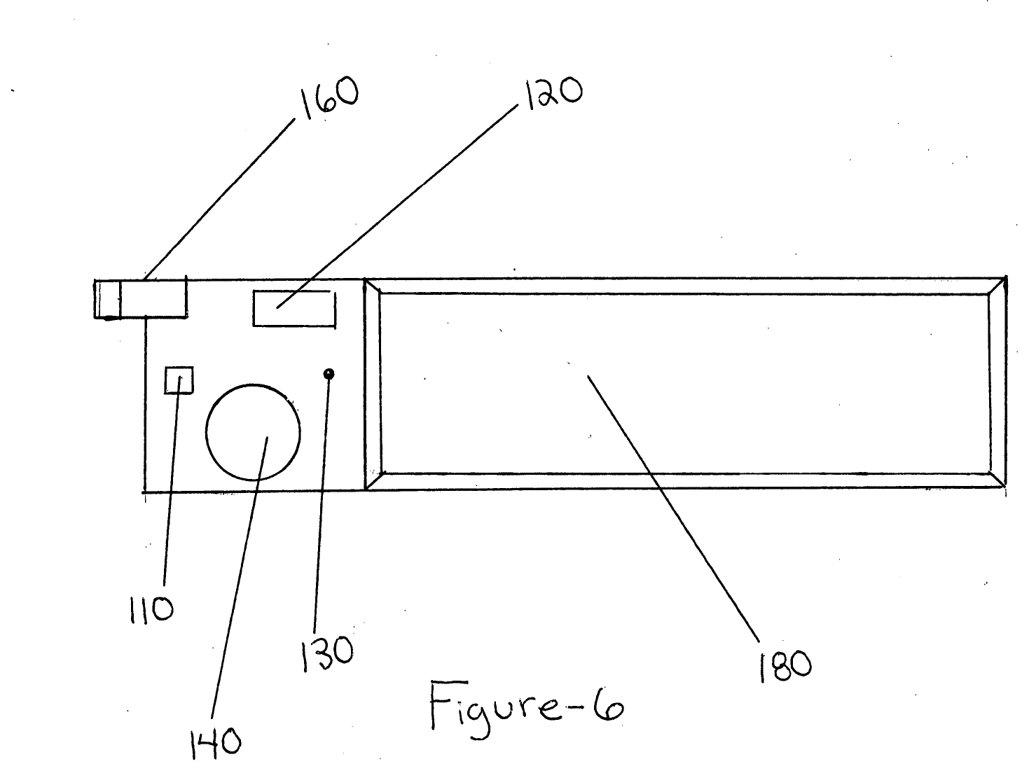

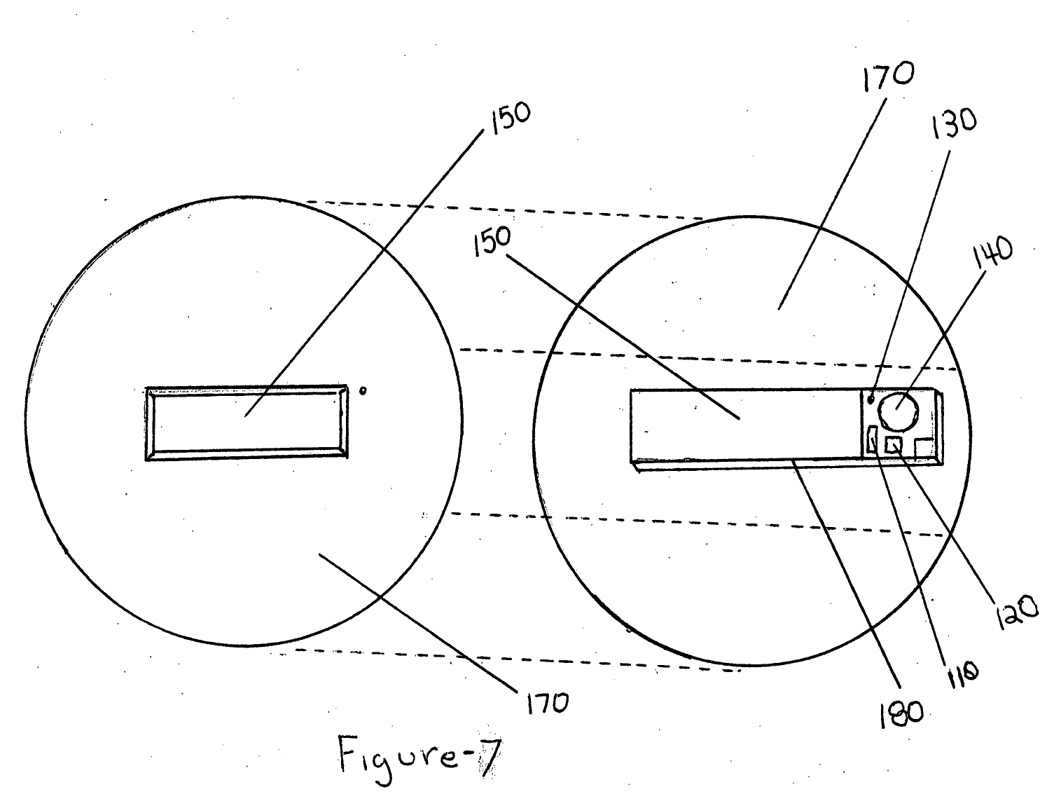

What is claimed is:

1. An elapsed time tracking device comprising: an electronic memory means, the memory means having a planar rectangular shape, an electronic counter means, the counter means connected with circuitry to the memory means, a generally rectangular LCD screen, the LCD display screen and circuitry being connected to the memory means and counter means, a battery, the battery attached to the circuitry of the memory means, counter means, LCD screen, and counter device reset wires, counter device reset wires being connected to the counter means, the battery, and the memory means, and removably connected to a contact plate to establish a completed circuit, the completed circuit initiates a new counter sequence to be displayed in the LCD display screen each time the circuit is broken and then re-established by means of the counter device reset wires and contact plate, the new counter sequence being stored in the electronic memory means from which it can be retrieved by the user and reviewed on the LCD display screen.

2. The elapsed time tracking device of claim 1 wherein the electronic memory means, the electronic counter means, a generally rectangular LCD screen, the battery, and the counter device reset wires are embodied in the cap of a prescription medicine container, while the contact plate is embodied within the prescription medicine container.

3. The elapsed time tracking device of claim 1 wherein the electronic memory means, the electronic counter means, a generally rectangular LCD screen, the battery, and the counter device reset wires are embodied in the circular planar bottom of a prescription medicine container, the counter device reset wires extend upward from the bottom of the container towards the top of the container, while the contact plate is embodied within the prescription medicine cap.

4. The elapsed time tracking device of claim 1 wherein the electronic memory means, the electronic counter means, a generally rectangular LCD screen, the battery, and the counter device reset wires are encased in a generally curved housing and adhered to the exterior surface of the prescription medicine container while the contact plate is embodied within the prescription medicine cap.

5. The elapsed time tracking device of claim 1 wherein the electronic memory means, the electronic counter means, a generally rectangular LCD screen, the battery, and the counter device reset wires are encased within a rectangular housing attached to an item such as one door or drawer of a refrigerator appliance, gun case, cabinet, closet, dresser, desk, gate, etc., while the contact plate is encased within a housing that attaches to a second portion of an item such as those listed above, so as to dispose the two housing in close proximity to allow the elapsed time tracking device to function.

6. The elapsed time tracking device of claim 1 wherein the electronic counter means progressively counts time from 0 days, 0 hours, 0 minutes until reset by breaking the circuit and re-establishing the circuit.

7. The elapsed time tracking device of claim 1 wherein the electronic memory means, the electronic counter means, a generally rectangular LCD screen, the battery, and the counter device reset wires are encased within the lid or cap of a container such as a jar, can, box, tub, dish, jug, bottle, while the contact plate attaches to the body of a container such as those listed above so as to allow the elapsed time tracking device to function.

8. The elapsed time tracking device of claim 1 wherein the electronic memory means, the electronic counter means, a generally rectangular LCD screen, the battery, and the counter device reset wires are embodied within first and second components of an electronic device such as a laptop computer or cell phone, so as to allow the elapsed time tracking device to function when the electronic device is used.

9. The elapsed time tracking device of claim 1 that will operate in one of two modes, an “in use” or “on” mode, and a “hibernation” mode, wherein the display will remain in “hibernation” mode during non use to minimize battery usage, wherein the “on” mode, which displays the LCD, can be activated by means of wiggling or otherwise moving the cap slightly which will thereby activate the LCD display portion of the invention

10. The elapsed time tracking device of claim 1 that will keep a stored memory record of the amount of elapsed time from the last use, and thereby provide medical time line in the event of a death or sudden illness, and forensic time lines in the event of death by overdose.

11. The elapsed time tracking device of claim 1 that will automatically reset to zero time elapsed after each use.

12. The elapsed time tracking device of claim 1 that embodies LED display hibernation for minimizing battery usage.

13. An elapsed time tracking device comprising: an electronic memory means, the memory means having a planar rectangular shape, an electronic counter means, the counter means connected with circuitry to the memory means, a generally rectangular LCD screen, the LCD display screen and circuitry being connected to the memory means and counter means, a battery, the battery attached to the circuitry of the memory means, counter means, LCD screen, USB connection, wireless transmitter, and counter device reset wires, counter device reset wires being connected to the counter means, the battery, and the memory means, and removably connected to a contact plate to establish a completed circuit, the completed circuit initiates a new counter sequence to be displayed in the LCD display screen each time the circuit is broken and then re-established, the new counter sequence being stored in the electronic memory means from which it can be retrieved by the user, reviewed on the LCD display screen, and transferred to an electronic device such as a computer or cell phone by means of utilizing the USB connection interface.
